(19) United States
(12) Patent Application Publication
(10) Pub. No.: US 2009/0212704 A1
(43) Pub. Date: Aug. 27, 2009

(54) CERAMIC DISCHARGE VESSEL WITH CHROMIUM-COATED NIOBIUM FEEDTHROUGH AND DISCHARGE LAMP CONTAINING SAME

(75) Inventors: George C. Wei, Weston, MA (US); Domenic Checca, Stoneham, MA (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 12/038,311

(22) Filed: Feb. 27, 2008

(51) Int. Cl. H01J 9/26; H01J 17/18

(52) U.S. Cl. 313/623; 445/44

(57) ABSTRACT

There is described a lamp having a ceramic discharge vessel with a niobium feedthrough that has been coated with a layer of chromium to provide oxidation resistance. In a preferred method, a slurry containing chromium powder is applied to the niobium feedthrough and dried. A sub-assembly is formed by inserting the coated niobium feedthrough into an annular polycrystalline alumina (PCA) disc and heated in vacuum to 1700° C. to 1900° C. to bond the feedthrough to the PCA and form the sub-assembly and an oxidation-resistant coating on the feedthrough. The sub-assembly is then sealed to a ceramic body of the discharge vessel in a conventional manner.

### TECHNICAL FIELD

This invention relates to high-intensity discharge (HID) lamps and more particularly to the ceramic discharge vessels of such lamps.

### BACKGROUND OF THE INVENTION

HID lamps such as high-pressure sodium lamps and ceramic metal halide lamps are efficient sources of light. The ceramic discharge vessel (also referred to as an arc tube or burner) at the heart of these lamps must be translucent and capable of withstanding the high-temperature and high-pressure conditions present in an operating HID lamp. The preferred ceramic for forming discharge vessels for HID lamp applications is polycrystalline alumina (PCA), although other ceramics such as sapphire, yttrium aluminum garnet, dysprosium oxide, aluminum nitride and aluminum oxynitride may also be used.

In conventional ceramic discharge vessels, conductive metallic feedthroughs are used to bring electrical energy into the discharge space. However, making the hermetic seal between the ceramic vessel and the metallic feedthrough can be troublesome because of the different properties of the materials, particularly with regard to the thermal expansion coefficients. In the case of polycrystalline alumina, the seal typically is made between the PCA ceramic and a niobium feedthrough since the thermal expansion of these materials is very similar. The niobium feedthrough is joined with at least a tungsten electrode which is used to form the point of attachment for the arc because it has a significantly higher melting point compared to niobium.

Niobium however cannot be exposed to air during lamp operation since it will oxidize and cause lamp failure. This necessitates that the discharge vessel be operated in either a vacuum or inert gas environment, which increases cost and the overall size of the lamp. Thus, it would be advantage to have a niobium feedthrough that is resistant to oxidation and still retains desirable sealing properties.

### SUMMARY OF THE INVENTION

It is, therefore, an object of the invention to obviate the disadvantages of the prior art.

It is an object of the invention to provide a niobium feedthrough for ceramic discharge vessels having greater oxidation resistance.

It is another object of the invention to provide a method of making a seal in a ceramic discharge vessel.

It is a further object of the invention to provide a high-intensity a discharge lamp with a ceramic discharge vessel that may operated in an open-air fixture without an outer jacket.

In accordance with one object of the invention, there is provided discharge lamp that comprises:

a ceramic body formed of polycrystalline alumina;

the ceramic body having at least one seal and enclosing a discharge space, the discharge space containing a discharge sustaining medium and at least one electrode; and

the at least one seal having a niobium feedthrough sealed therein for making an electrical connection between the at least one electrode and an external power source, the niobium feedthrough having a layer consisting of chromium or an alloy of chromium and niobium on an external surface to provide oxidation resistance.

In accordance with another object of the invention, there is provided a method of making a ceramic discharge vessel that comprises:

forming a tubular polycrystalline body;

forming a pair of annular polycrystalline alumina sealing discs;

forming a pair of niobium feedthroughs, each of said feedthroughs having an area for sealing to said discs;

providing coating an external surface of the niobium feedthroughs with a layer consisting of chromium;

inserting said each of said feedthroughs into one of said discs to form sub-assemblies;

firing said sub-assemblies in a vacuum at 1700° C. to 1900° C., with about 1850° C. being preferred, to seal the discs to the respective sealing area; and

subsequently inserting said fired sub-assemblies into opposite ends of said tubular body and sealing thereto.

In a preferred embodiment, there is provided a discharge lamp that comprises:

a tubular body formed of polycrystalline alumina;

a pair of seals, each sealing an end of said body; and

said seals each comprising an annular polycrystalline alumina disc, the outer surface of said disc being bonded to said body, and a tubular niobium feedthrough sealed to the inner surface of said disc in a seal area, the niobium feedthrough having a layer consisting of chromium or an alloy of chromium and niobium on an external surface, the layer in the seal area being between the feedthrough and the disc.

The Cr-coated niobium feedthrough allows a lamp to be constructed with a ceramic discharge vessel and operated without the need for an outer jacket, getter, glass stem or the associated processing and assembling of these components.

### BRIEF DESCRIPTION OF THE DRAWINGS

FIG. 1 is a sectional view of a sub-assembly having a Cr-coated niobium feedthrough;

FIG. 2 is a plan view of an annular ring of a sub-assembly;

FIG. 3a is a diagrammatic sectional view of an embodiment of the invention; and

FIG. 3b is a diagrammatic sectional view of an alternate embodiment.

### DETAILED DESCRIPTION OF THE INVENTION

For a better understanding of the present invention, together with other and further objects, advantages and capabilities thereof, reference is made to the following disclosure and appended claims taken in conjunction with the above-described drawings.

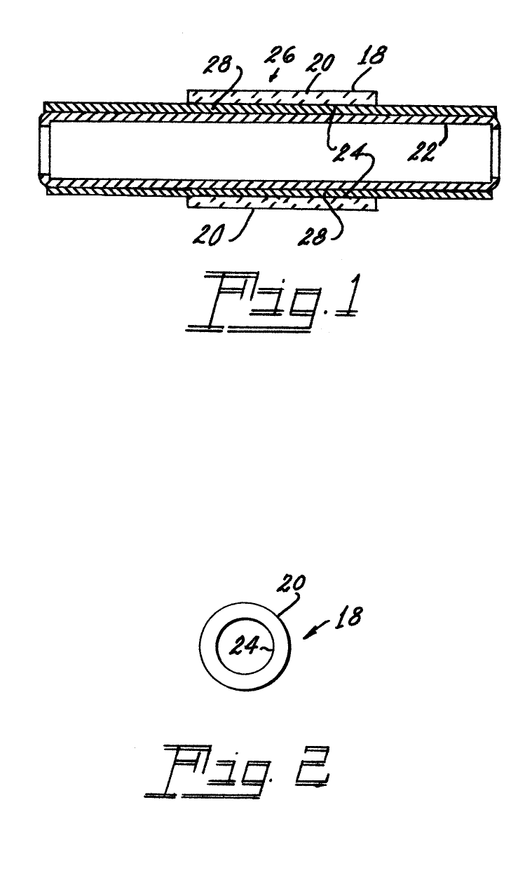

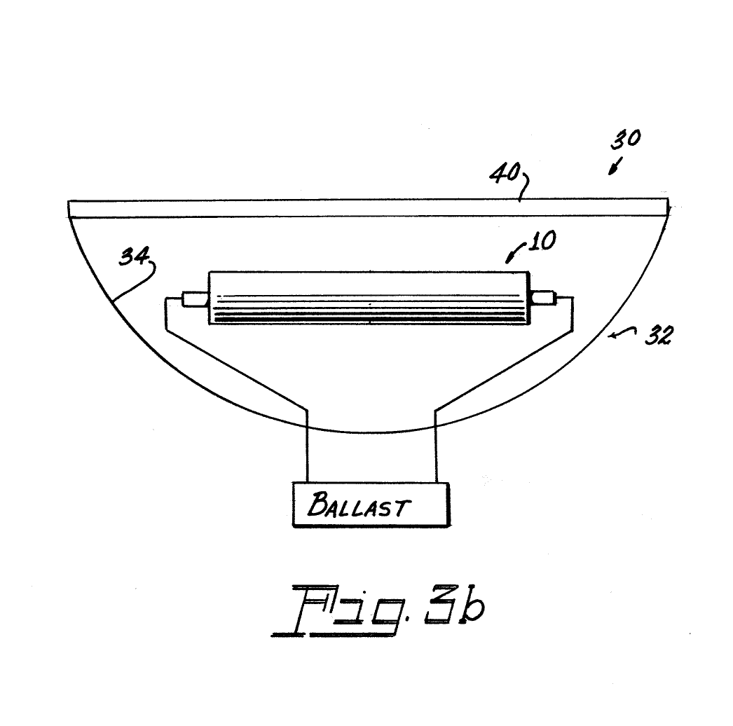

Referring now to the drawings with greater particularity, there is shown in FIGS. 1-3 a preferred embodiment of the invention. As shown in FIG. 3a, the light source 30 comprises an open-air fixture 32 having a reflecting body 34 with a closed end 36 and an open end 38. A ceramic discharge vessel in the form of arc tube 10 is mounted within the reflecting body 34. The arc tube 10 comprises a tubular ceramic body 12 formed of polycrystalline alumina and has a pair of seals 14, each seal 14 sealing an end 16 of the ceramic body 12. The ceramic body 12 when sealed encloses a discharge space 60. In this embodiment, the ceramic discharge vessel is tubular in shape. However, it is to be understood that other configurations are possible including spherical discharge vessels. When completed the arc tube 10 contains an arc discharge sustaining medium. In the case of a high-pressure sodium lamp, the medium necessary for the lamp operation comprises a sodium amalgam and a gas fill.

The seals 14 comprise a sub-assembly 26 that is comprised of an annular polycrystalline alumina disc 18, the outer surface 20 of which is bonded to the body 12. A tubular niobium feedthrough 22 is sealed to the inner surface 24 of the disc 18 and extends beyond the edge of the disc at either side. A tungsten electrode 61 is attached to an end of each niobium feedthrough 22. The niobium feedthrough 22 has a layer 28 consisting of chromium or an alloy of chromium and niobium that is bonded to its external surface. By altering the niobium feedthrough with the chromium layer, it becomes resistant to oxidation, thus permitting open-air operation.

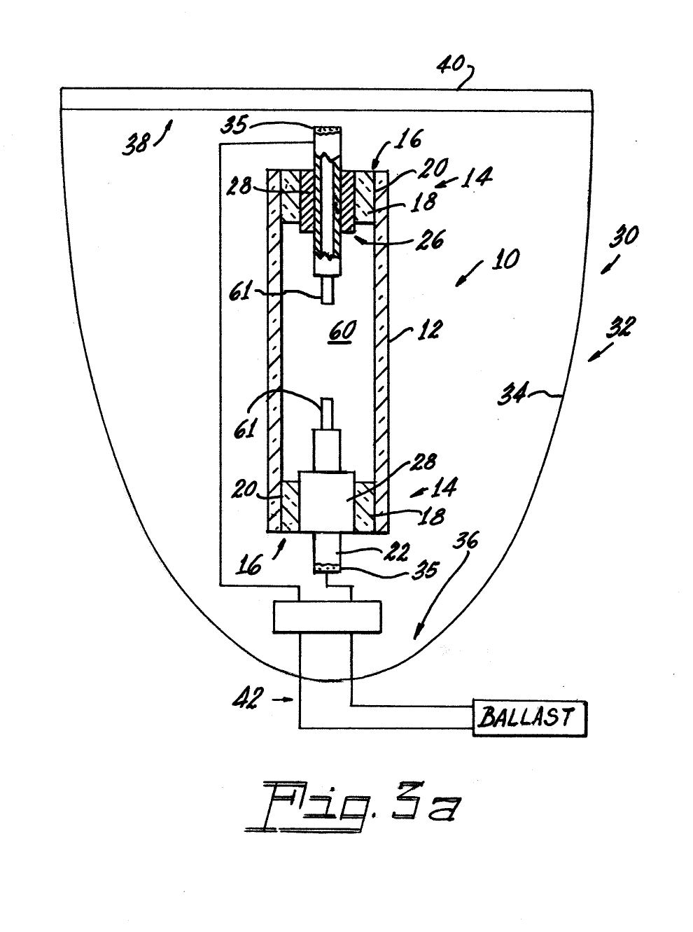

An enlarged view of the sub-assembly and the niobium feedthrough is illustrated in FIG. 1 and a plan view of the disc 18 is shown in FIG. 2, all of the sizes being exaggerated for illustrative purposes

Since the arc tube 10 is operated in an air environment, the reflecting body 34 can be used as a ceiling mounted lamp with the open end 38 remaining uncovered. However, a cover or lens 40 can be provided to alter the beam if desired.

Electrical connections 42 from the ballast to the arc tube 10 can enter the reflecting body 34 from the closed end 36. The ballast supplies and conditions the electrical power to the arc tube from an external power source (not shown) in order to generate a stable arc discharge between the electrodes 61.

The chromium layer is preferably applied via a chromium powder-methanol slurry. The slurry is brushed onto the external surface of the niobium tube and dried to a thickness of about 100-500 μm.

To prepare the arc tubes, the niobium tubes 22, with the chromium layer 28 applied, are fitted into the annular discs 18, which have been pre-fired, to form a sub-assembly, which is then fired at 1700 to 1900° C., with 1850° C. being preferred, for 30 minutes to four hours, with one hour being preferred, in a vacuum.

To insure good bonding, the predicted sintered ID of the annular discs 18 was selected to be 6 to 20% smaller than the OD of the niobium tubes 22, with 10% being preferred. After the 1850° C. firing for one hour in vacuum, the chromium-coated niobium tubes are well bonded to the PCA annular discs 18. The annular discs 18 sintered to a state of visual translucency. The vacuum firing is selected over hydrogen firing because hydrogen firing would embrittle the niobium. The vacuum firing keeps the niobium sufficiently ductile to allow the niobium to undergo pinch sealing at ambient temperature, thus avoiding the usual high-temperature glass frit sealing.

However, as another example, glass frit sealing can be used for joining an already sintered tubular body and the sintered sub-assemblies of Cr-coated, Nb-PCA rings. This has the advantage of allowing the use of an already sintered tubular body, which can be continuously produced in a hydrogen tunnel furnace, whereas the vacuum-sintered sub-assembly of Cr-coated, Nb-PCA rings is done in a batch, vacuum furnace.

During sintering the chromium first forms a liquid film which begins to migrate into the niobium and conversely allows the niobium to migrate to the PCA surface 24 of the annular disc 18. The liquid film then diminishes and facilitates the formation of a good bond between the niobium and the PCA of the annular disc 18. The layer of chromium (or alloy of chromium and niobium) left behind on the surface of the niobium acts as a protective layer against oxidation of the niobium in air. It should be noted that other metals, in particular, Ti and Zr, were tested but were determined to either inoperable or undesirable for use with PCA. No signs of melting were observed for a PCA/Zr/Nb/PCA test stack heated at 1850° C. in vacuum and Ti vaporizes and diffuses into the PCA causing it to turn an undesirable pinkish color when heated at only 1615° C. in vacuum.

After the sub-assembly seals are completed, the sub-assemblies are inserted into the ends of the tubular body and the arc tube is fabricated by any one of the techniques previously described. Subsequently, the niobium tube is pinched-sealed, as at 35.

Thus, the arc tube 10 can be mounted directly in a fixture, as shown in FIGS. 3a and 3b, and operated in air with no need for an outer jacket and an inert or vacuum atmosphere.

As shown in FIG. 3a, the discharge vessel can be mounted along the central axis of the fixture (as defined by the reflecting body 34) with a 70-90° covering angle or it can be mounted perpendicular to the central axis as shown in FIG. 3b with a wide (e.g., 120°) covering angle.

The voltage and wall temperature of the discharge vessel operating in air will be lower than a similar discharge vessel operating in a vacuum outer jacket; however, this can be optimized by changing the dimensions of the PCA body and/or the composition of the discharge medium to maintain the same or higher efficiency.

Thus, there is provided a high intensity discharge lamp that operates in air without the necessity of an outer jacket and isolated air-less environment as well as the associated processing and assembly.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. A discharge lamp comprising:
a ceramic body formed of polycrystalline alumina;
the ceramic body having at least one seal and enclosing a discharge space, the discharge space containing a discharge sustaining medium and at least one electrode; and
the at least one seal having a niobium feedthrough sealed therein for making an electrical connection between the at least one electrode and an external power source, the niobium feedthrough having a layer consisting of chromium or an alloy of chromium and niobium on an external surface to provide oxidation resistance.

2. The discharge lamp of claim 1 wherein the discharge lamp is mounted in an open-air fixture having a reflecting body with an open end.

3. The discharge lamp of claim 2 wherein the open end has a cover.

4. A discharge lamp comprising:
a tubular body formed of polycrystalline alumina;
a pair of seals, each sealing an end of said body; and
said seals each comprising an annular polycrystalline alumina disc, the outer surface of said disc being bonded to said body, and a tubular niobium feedthrough sealed to the inner surface of said disc in a seal area, the niobium feedthrough having a layer consisting of chromium or an alloy of chromium and niobium on an external surface, the layer in the seal area being between the feedthrough and the disc.

5. A method of making a ceramic discharge vessel, comprising:
forming a tubular polycrystalline body;
forming a pair of annular polycrystalline alumina sealing discs;
forming a pair of niobium feedthroughs, each of said feedthroughs having an area for sealing to said discs;
providing coating an external surface of the niobium feedthroughs with a layer consisting of chromium;
inserting said each of said feedthroughs into one of said discs to form sub-assemblies;
firing said sub-assemblies in a vacuum at 1700° C. to 1900° C. to seal the discs to the respective sealing area; and
subsequently inserting said fired sub-assemblies into opposite ends of said tubular body and sealing thereto.

6. The method of claim 5 wherein said chromium layer is applied by coating the niobium feedthroughs with a slurry of chromium and methanol; and
drying said layer to provide a thickness of chromium between 100-500 μm.

7. The method of claim 5 wherein the sub-assemblies are heated at about 1850° C.

8. A feedthrough for a ceramic discharge vessel, the feedthrough comprising a niobium tube having a layer consisting of chromium or an alloy of chromium and niobium on an external surface to provide oxidation resistance.
